(19) United States
(12) Patent Application Publication
(10) Pub. No.: US 2008/0115604 A1
(43) Pub. Date: May 22, 2008

(54) Apparatus for Fixing Gear Boxes of Liquid Material Spray Printer

(76) Inventor: Hyung-Dae Moon, Seoul (KR)

Correspondence Address: THE FARRELL LAW FIRM, P.C., 333 EARLE OVINGTON BOULEVARD, SUITE 701, UNIONDALE, NY, 11553, US

(21) Appl. No.: 11/597,241

(22) PCT Filed: May 17, 2005
(86) PCT No.: PCT/KR05/01447

§ 371 Date: Nov. 20, 2006

(30) Foreign Application Priority Data
May 20, 2004 (KR) 10-2004-0036041

(51) Int. Cl. B41J 23/02

(52) U.S. Cl. 74/30

(57) ABSTRACT

Disclosed is an apparatus for fixing a gearbox of a liquid material spray printer, which enables accurate printing by exactly transferring a driving force of the gearbox to a transferring table. The apparatus includes a pinion gear engaged with a rack gear mounted to the transferring table so that the transferring table reciprocates within a range, and fixes the gearbox installed to a guide flat plate guiding reciprocation of the transferring table. The apparatus includes a sliding member including upper and lower sliders coupled with each other slidably in its length direction, wherein the upper and lower sliders are coupled to the guide flat plate and the gearbox respectively so that the gear box is slidable within a range perpendicularly to reciprocation direction of the transferring table; and an elastic member installed to the gearbox for biasing the pinion gear to be closely contacted with the rack gear.

### TECHNICAL FIELD

The present invention relates to an apparatus for fixing a gearbox of a liquid material spray printer, and more particularly to an apparatus for fixing a gearbox of a liquid material spray printer, which enables accurate printing by exactly transferring a driving force of the gearbox to a transferring table that is reciprocated by the gearbox.

### BACKGROUND ART

Generally, a liquid material spray printer is a device for coating liquid material on a surface of a subject to print a predetermined image. As an example of such a liquid material spray printer, there is an ink-jet printer that may coats an ink material for printing.

The liquid material spray printer includes a transferring table on which a subject to be coated is mounted, a transferring device for reciprocating the transferring table so that liquid material may be coated on the subject, a lifting device for lifting the transferring device to a height suitable for liquid material coating, and a spray assembly installed at a substantial center of the transferring device to be capable of reciprocating in a direction perpendicular to a moving direction of the transferring table. The spray assembly contains liquid material and is provided with a nozzle capable of spraying the liquid material to the subject to be coated. Such a liquid material spray printer is disclosed in Korean Utility Model Registration No. 20-0292979 as an example.

The transferring device includes a pulley rotated by a driving motor, and a timing belt running on an endless track by means of the pulley. That is to say, the transferring table is installed to the timing belt to reciprocate within a predetermined range. However, this transferring device has a problem that it may carry a subject to an accurate distance due to drooping of the timing belt. That is to say, since the transferring table may not be moved during the printing procedure using the spray assembly, the printing work cannot be made precisely.

In order to solve such problems, there has been proposed a method of installing a rack gear to a lower surface of the transferring table and then reciprocating the transferring table by use of a gearbox including a pinion gear engaged with the rack gear. This method enables precise movement in terms of the gears, compared with the case using a timing belt. However, if the pinion gear is not closely contacted with but separated from the rack gear, the driving force may not be transferred to the transferring table, thereby not ensuring accurate printing.

### DISCLOSURE OF INVENTION

### Technical Problem

The present invention is designed to solve the problems of the prior art, and therefore an object of the invention is to provide an apparatus for fixing a gearbox of a liquid material spray printer, which enables accurate printing by making a driving force of the gearbox reciprocating a transferring table be accurately transferred to the transferring table.

### Technical Solution

In order to accomplish the above object, the present invention provides an apparatus for fixing a gearbox of a liquid material spray printer, which includes a pinion gear to be engaged with a rack gear mounted to a lower surface of a transferring table so that the transferring table reciprocates within a predetermined range, and which fixes the gearbox installed to a guide flat plate that guides reciprocation of the transferring table, the apparatus comprising: a sliding member including upper and lower sliders coupled with each other to be slidable in a length direction thereof, wherein one of the upper and lower sliders is coupled to the guide flat plate and the other of the upper and lower slider is coupled to the gearbox so that the gear box is slidable within a predetermined range in a direction perpendicular to reciprocation direction of the transferring table; and an elastic member installed to the gearbox for biasing the pinion gear to be closely contacted with the rack gear.

Preferably, a concave groove having a shape conforming to the sliding member is formed on at least one of the guide flat plate and the gearbox so that the sliding member is slidably installed therein.

More preferably, the upper slider has roller members installed at regular intervals to first bending portions formed by bending side ends of the upper slider along a length thereof, and wherein the lower slider includes: second bending portions formed by bending both side ends of the lower slider along a length thereof so as to support roller shafts of the roller members; and anti-separation projections formed at both ends of the lower slider so as to prevent the upper slider from departing from the lower slider.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a front view showing a liquid material spray printer to which an apparatus for fixing a gearbox of the liquid material spray printer according to a preferred embodiment of the present invention is installed;

FIG. 2 is a plane view showing the liquid material spray printer of FIG. 1;

FIG. 3 is a sectional view taken along III-III′ line of FIG. 2;

FIG. 4 is a perspective view showing an apparatus for fixing a gearbox of a liquid material spray printer according to a preferred embodiment of the present invention;

FIG. 5 is a exploded perspective view showing a sliding member of the apparatus shown in FIG. 4; and

FIG. 6 is a sectional view taken along VI-VI′ line of FIG. 1.

### BEST MODE FOR CARRYING OUT THE INVENTION

The present invention will be described in detail referring to the drawings the terms used should not be construed as limited to general and dictionary meanings but based on the meanings and concepts of the invention on the basis of the principle that the inventor is allowed to define terms appropriate for the best explanation. Therefore, the description herein the scope of the invention be understood that other and modifications could be made thereto without departing from the spirit and scope of the invention.

In addition, in this specification, in order to describe an apparatus for fixing a gearbox of a liquid material spray printer according to a preferred embodiment of the present invention, a liquid material spray printer to which the apparatus for fixing a gearbox is installed is also described together.

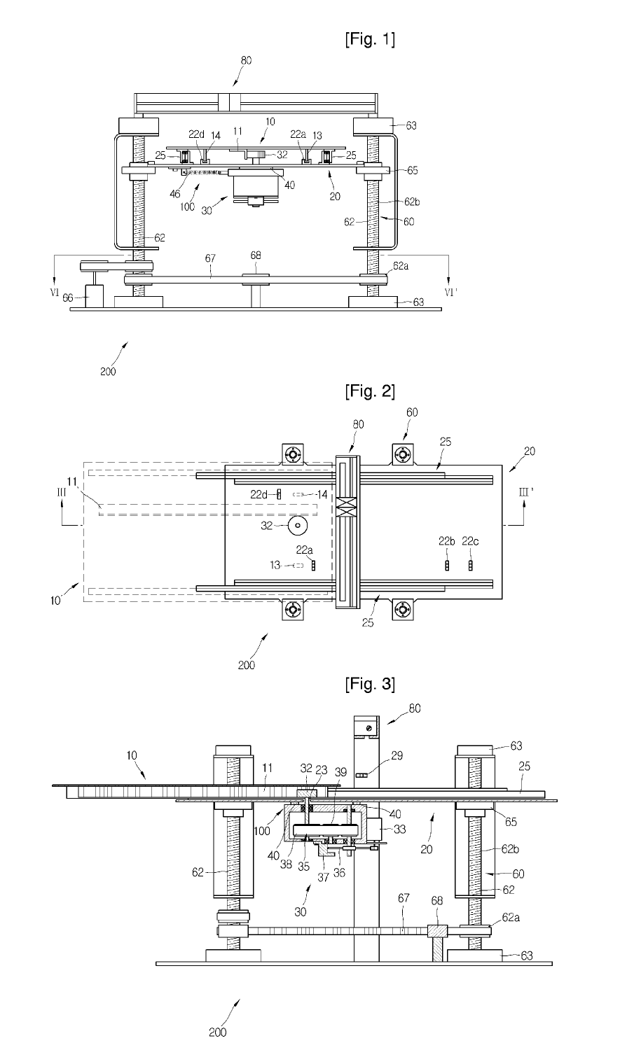

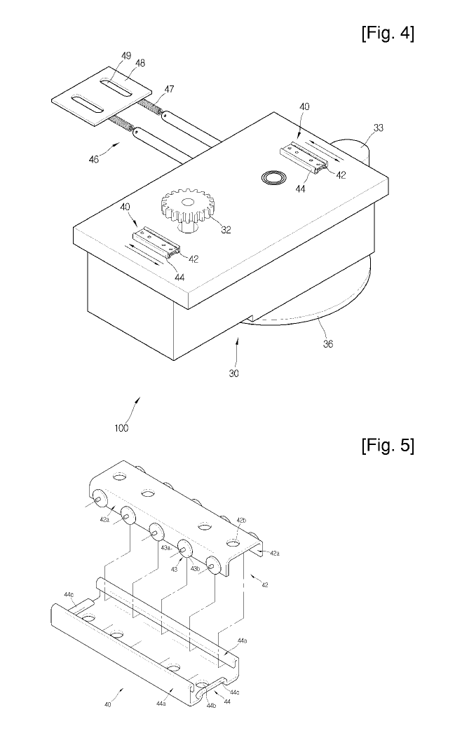

FIG. 1 is a front view showing a liquid material spray printer to which an apparatus for fixing a gearbox of the liquid material spray printer according to a preferred embodiment of the present invention is installed, FIG. 2 is a plane view showing the liquid material spray printer of FIG. 1, FIG. 3 is a sectional view taken along III-III′ line of FIG. 2, and FIG. 4 is a perspective view showing an apparatus for fixing a gearbox of a liquid material spray printer according to a preferred embodiment of the present invention.

Referring to FIGS. 1 to 4, the liquid material spray printer 200 includes a transferring table 10 to which a subject to be coated is mounted, a guide flat plate 20 installed below the transferring table 10, a gearbox 30 installed to the guide flat plate 20 to reciprocate the transferring table 10, a gearbox fixing apparatus 100 for slidably fixing the gearbox 30 to the guide flat plate 20, a lifting device 60 for lifting the guide flat plate 20, and a spray assembly 70 for coating liquid material.

The transferring table 10 includes a rack gear 11 installed in a length direction thereof, and protrusions 13, 14 that are detected by sensors 22a, 22b, 22c, 22d sensing a printing range and a reciprocating range respectively.

The rack gear 11 is installed in a length direction on the lower surface of the transferring table 10 to be engaged with a pinion gear 32, as shown in FIGS. 2 and 3. As described later, the rack gear 11 is closely contacted with the pinion gear 32 by means of an elastic member 46.

The protrusions 13, 14 include a first protrusion 13 detected by the first and second sensors 22a, 22b sensing the printing range and the third sensor 22c sensing an end position of the reciprocating range, and a second protrusion 14 detected by the fourth sensor 22d sensing a start position of the reciprocating range.

That is to say, if the transferring table 10 advances so that the first protrusion 13 reaches the first sensor 22a, the spray assembly 80 starts printing, while, if the first protrusion 13 reaches the second sensor 22b, the printing is stopped. In addition, if the first protrusion 13 reaches the third sensor 22c, the transferring table 10 stops advancing. And, if the transferring table 10 moves rearward so that the second protrusion 14 reaches the fourth sensor 22d, the rear movement is stopped.

The guide flat plate 20 is a flat plate to which the gearbox 30 is installed, and which is lifted by means of rotation of a lifting shaft 62. The guide flat plate 20 has a through hole 23 through which the pinion gear 32 is installed, a guide member 25 for guiding reciprocation of the transferring table 10, and sensors 22a, 22b, 22c, 22d sensing movement of the transferring table 10.

The through hole 10 is formed at a position that ensures close contact between the pinion gear 32 and the rack gear 11. The guide member 25 is installed to both ends of the lower surface of the transferring table 10 along its length direction and guides reciprocation of the transferring table 10. Such a guide member 10 is widely used in printers, and not described in detail here. Meanwhile, the sensors 22a, 22b, 22c, 22d are already described above, and not described again here.

The gearbox 30 is a unit for transferring a driving force from a driving motor 33 to the rack gear 11, as shown in FIGS. 3 and 4. The gearbox 30 includes a gear assembly 35 for regulating RPM, and a pinion gear 32 for transferring the driving force from the gear assembly 35 to the rack gear 11.

Preferably, the gear assembly 35 includes an encoder 36 and an encoder sensor 37 so as to control movement of the transferring table 10. That is to say, the rotation of the encoder 36 may be controlled using the encoder sensor 37 and a controller (not shown) so as to control movement of the transferring table 10.

In addition, the gear assembly 35 may further include a tension gear 39 giving a predetermined tension to a belt 38. The tension gear 39 makes the belt 38 move in a curved path, thereby giving a tension to the belt 38. The position of the tension gear 39 is controlled using a positioning means. That is to say, the positioning means is used for controlling a magnitude of the tension.

The pinion gear 32 having a common configuration is installed through the through hole 23 and transfers a driving force from the gear assembly 35 to the rack gear 11.

The gearbox 30 is installed to the guide flat plate 20 by use of the gearbox fixing apparatus 100 as shown in FIGS. 3 to 5.

The gearbox fixing apparatus 100 includes a sliding member 40 for slidably coupling the gearbox 30 to the guide flat plate 20, and an elastic member 46 for biasing the pinion gear 32 to be closely contacted with the rack gear 11.

The sliding member 40 includes an upper slider 42 and a lower slider 44 that are combined to be slidable with each other in a length direction. The sliding member 40 is installed between the upper surface of the gearbox 30 and the guide flat plate 20 so that the gearbox 30 may slide within a predetermined range in a direction perpendicular to the reciprocating direction of the transferring table 10. That is to say, one of the upper and lower sliders 42, 44 is coupled to the guide flat plate 20, and the other of the upper and lower sliders 42, 44 is coupled to the upper surface of the gearbox 30.

The upper slider 42 has first bending portions 42a formed in both side ends thereof along its length, a roller member 43 installed at regular intervals to the first bending portions 42a, and a coupling hole 42b for coupling with the guide flat plate 20.

The first bending portions 42a are formed by bending both side ends of the upper slider 42 along its length. The first bending portion 42a has shaft holes formed at regular intervals so that roller shafts 43a may be inserted and installed therein.

The roller member 43 includes a roller 43b, and a roller shaft 43a supporting the roller 43b.

The roller 43b is supported by the roller shaft 43a, and ensures the upper slider 42 to smoothly slide with respect to the lower slider 44 when the upper slider 42 presses the lower slider 44.

The roller shaft 43a is installed in the shaft hole to be capable of rotating with being supported by the first bending portions 42a. The roller shaft 42a ensures the upper slider 42 to smoothly slide on the lower slide 44 when the upper slider 42 receives a force that makes the upper slider 42 be separated from the lower slider 44.

The coupling hole 42b is used for installing a coupling member (not shown) that couples the upper slider 42 to the guide flat plate 20.

The lower slider 44 includes second bending portions 44a formed in a length direction thereof to support the roller shaft 42a, a coupling hole 44b for coupling with the gearbox 30, and anti-separation projections 44c formed at both ends thereof to prevent the upper slider 42 from being separated therefrom. The lower slider 44 has a width that ensures the upper slider 42 to be installed between the second bending portions 44a.

The second bending portions 44a are formed by bending both side ends of the lower slider 44 along its length. The roller shaft 43a is inserted and installed in the second bending portions 44a. That is to say, the second bending portions 44a support the roller shaft 43a to be smoothly slid.

The coupling hole 44b is used for installing a coupling member (not shown) that couples the lower slider 44 to the gearbox 30.

The anti-separation projections 44c are formed by protruding both ends of the lower slider 44 so that the roller shaft 43a may be hooked thereto. The anti-separation projections 44c prevent the upper slider 42 from departing from the lower slider 42. As shown in FIG. 4, since the upper slider 42 may slide with respect to the lower slider 44 within a predetermined range, namely between the anti-separation projections 44c, the gearbox 30 may slide within a predetermined range with respect to the reciprocating direction of the transferring table 10.

Meanwhile, FIG. 4 shows that the upper slider 42 is coupled to the guide flat plate 20 and the lower slider 44 is coupled to the upper surface of the gearbox 30, but it is also possible that the upper slider 42 is coupled to the upper surface of the gearbox 30 and the lower slider 44 is coupled to the guide flat plate 20.

Preferably, at least one of the guide flat plate 20 and the gearbox 30 has a concave groove (not shown) having a shape conforming to the sliding member 40 so that the sliding member 40 may slide therein. This concave groove may save a space as much as the height of the sliding member 40.

The elastic member 46 includes an elastic spring 47, and a fixing flat plate 48 for fixing the elastic spring 47 to the guide flat plate 20 as shown in FIG. 4. The elastic member 46 biases the pinion gear 32 to be closely contacted with the rack gear 11.

The elastic spring 47 has one end connected to the gearbox 30 and the other end connected to the fixing flat plate 48. The number of elastic springs 47 may be selected in consideration of weight of the gearbox 30 and required biasing force.

The fixing flat plate 48 is installed to the lower surface of the guide flat plate 20 and fixes the other end of the elastic spring 47. The fixing flat plate 48 has a coupling hole 49 in which a coupling member for coupling with the guide flat plate 20 is installed.

As mentioned above, the gearbox fixing apparatus 100 of a liquid material spray printer according to this embodiment of the present invention makes the pinion gear 32 be closely contacted with the rack gear 11 by using the sliding member 40 and the elastic member 46 so that a driving force is accurately transferred. That is to say, the gearbox 30 may slide within a predetermined range by means of the sliding member 40 and at the same time the pinion gear 32 may be biased by the elastic member 46 to closely contact with the rack gear 11, thereby preventing the gear from running idle. Thus, it allows accurate and precise printing.

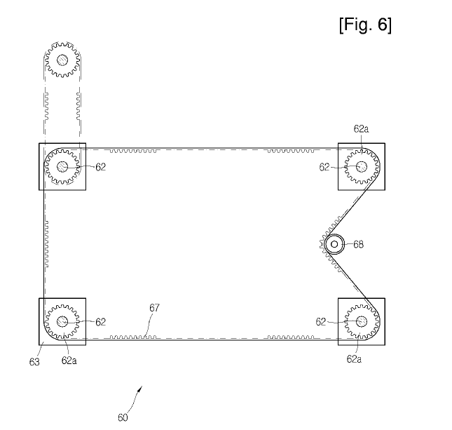

The lifting device 60 is a device for reciprocating the guide flat plate 20 within a predetermined range in a vertical direction as shown in FIGS. 1, 3 and 6. The lifting device 60 includes a lifting shaft 62 vertically installed, a bearing member 63 supporting the lifting shift 62, and a lifting member 65 installed to the lifting shaft 62 for vertically reciprocating the guide flat plate 20.

The lifting shaft 62 is rotated by a driving motor 66 to vertically reciprocate the lifting member 65. The lifting shaft 62 includes a shaft gear 62a for transferring a driving force, and a spiral ridge 62b formed on its outer circumference.

The shaft gear 62a transfers a rotational force of the driving motor 66 to the lifting shaft 62, and a plurality of shaft gears 62a are connected by a belt 67 and rotate together. That is to say, the shaft gears 62a mounted to each lifting shaft 62 are connected to each other by the belt 67 and rotate with the same revolution number to lift the guide flat plate 20.

The spiral ridge 62b is engaged with a spiral ridge formed on the inner circumference of the lifting member 65, and it makes the lifting member 65 be lifted by means of rotation of the lifting shaft 62.

Preferably, the lifting device 60 is provided with a tension pulley 68 that gives a predetermined tension to the belt 67. The tension pulley 68 is installed between the lifting shafts 62 to curve a path of the belt 67. Thus, the belt 67 is closely contacted with the shaft gear 62a to transfer a driving force exactly.

The bearing member 63 supports rotation of the lifting shaft 62 at upper and lower ends of the lifting shaft 62. The bearing member 63 has a common configuration supporting shaft behavior, and not described in detail here.

The lifting member 65 is installed to the lifting shaft 62 to support the guide flat plate 20, and has a spiral ridge on its inner circumference, which is engaged with the spiral ridge 62b of the lifting shaft 62. That is to say, the lifting member 65 supports the guide flat plate 20 and vertically reciprocates.

The spray assembly 80 contains liquid material and sprays the liquid material with reciprocating in a direction perpendicular to the moving direction of the transferring table 10. The spray assembly 80 is commonly used in printers, and not described in detail here.

Now, the operation procedure of the gearbox fixing apparatus 100 of a liquid material spray printer according to a preferred embodiment of the present invention is described in detail with reference to FIGS. 1 to 6. The gearbox fixing apparatus 100 is installed to the liquid material spray printer 200 and works together with it, so the operation of the liquid material spray printer 200 is described together.

First, a subject (not shown) to be coated is mounted on the upper surface of the transferring table 10. At this time, the subject is preferably mounted to a position corresponding to the first protrusion 13. In this case, the first sensor 22a detects the position of the subject and controls operation of the spray assembly 80. That is to say, if the transferring table 10 advances to make the first protrusion 13 reach the first sensor 22a, the spray assembly 80 starts printing.

Subsequently, a driving force is transferred to the rack gear 11 so that the transferring table 10 moves below the spray assembly 80. That is to say, the transferring table 10 advances so that the first protrusion 13 reaches the first sensor 22a.

After the subject is moved below the spray assembly 80 as mentioned above, a controller (not shown) and a height sensor 29 sense an actual distance between the spray assembly 80 and the upper surface of the subject and then compare it with an optimal coating distance. After the actual distance is compared with the optimal coating distance, the lifting device 60 lifts the guide flat plate 20 as much as the difference.

After the guide flat plate 20 is lifted to the optimal coating distance, the spray assembly 80 starts printing, and at this same time the transferring table 10 is moved at a predetermined speed. At this time, since the gearbox 30 is installed to be slidable in a direction perpendicular to the movement direction of the transferring table 10 and the elastic member 46 biases the gearbox 30 toward the rack gear 11, the pinion gear 32 is closely contacted with the rack gear 11. That is to say, the driving force is accurately transferred to move the transferring table 10 at an accurate speed, thereby ensuring exact and precise printing.

If the transferring table 10 advances and the first protrusion 13 reaches the second sensor 22b, coating of the liquid material is stopped. In addition, if the first protrusion 13 reaches the third sensor 22c, the transferring table 10 stops advancing.

Subsequently, the driving motor (not shown) transfers a driving force oppositely to move the transferring table 10 rearward to the printing start position.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

As described above, the gearbox fixing apparatus of a liquid material spray printer according to the present invention makes a driving force of the gearbox, reciprocating the transferring table, be accurately transferred to the transferring table, thereby ensuring precise printing.

1. An apparatus for fixing a gearbox of a liquid material spray printer, which includes a pinion gear to be engaged with a rack gear mounted to a lower surface of a transferring table so that the transferring table reciprocates within a predetermined range, and which fixes the gearbox installed to a guide flat plate that guides reciprocation of the transferring table, the apparatus comprising:
a sliding member including upper and lower sliders coupled with each other to be slidable in a length direction thereof, wherein one of the upper and lower sliders is coupled to the guide flat plate and the other of the upper and lower slider is coupled to the gearbox so that the gear box is slidable within a predetermined range in a direction perpendicular to reciprocation direction of the transferring table; and
an elastic member installed to the gearbox for biasing the pinion gear to be closely contacted with the rack gear.

2. The apparatus for fixing a gearbox of a liquid material spray printer according to claim 1,
wherein a concave groove having a shape conforming to the sliding member is formed on at least one of the guide flat plate and the gearbox so that the sliding member is slidably installed therein.

3. The apparatus for fixing a gearbox of a liquid material spray printer according to claim 2,
wherein the upper slider has roller members installed at regular intervals to first bending portions formed by bending side ends of the upper slider along a length thereof, and
wherein the lower slider includes:
second bending portions formed by bending both side ends of the lower slider along a length thereof so as to support roller shafts of the roller members; and
anti-separation projections formed at both ends of the lower slider so as to prevent the upper slider from departing from the lower slider.
